(19) United States
(12) Patent Application Publication
(10) Pub. No.: US 2004/0170840 A1
(43) Pub. Date: Sep. 2, 2004

(54) Chemical conversion coating agent and surface-treated metal

(75) Inventors: Masahiko Matsukawa, Nishitokyo-shi (JP); Kazuhiro Makino, Yokohama-shi (JP); Toshiaki Shimakura, Ichikawa-shi (JP)

Correspondence Address: CONNOLLY BOVE LODGE & HUTZ LLP, SUITE 800, 1990 M STREET NW, WASHINGTON, DC, 20036-3425, US

(73) Assignee: Nippon Paint Co., Ltd., Osaka-shi (JP)

(21) Appl. No.: 10/743,389

(22) Filed: Dec. 23, 2003

(30) Foreign Application Priority Data
Dec. 24, 2002 (JP) 2002-372770
Dec. 24, 2002 (JP) 2002-372773
May 28, 2003 (JP) 2003-150946
Dec. 2, 2003 (JP) 2003-403687

(51) Int. Cl. B32B 27/00

(52) U.S. Cl. 428/422.8; 428/474.4

(57) ABSTRACT

It is an object of the present invention to provide a chemical conversion coating agent containing no chromium and capable of applying good chemical conversion treatment which is equal to or more than chemical conversion treatment by zinc phosphate to all metals such as iron, zinc and aluminum.

A chemical conversion coating agent comprising:

at least one kind selected from the group consisting of zirconium, titanium and hafnium;

fluorine; and

a water-soluble epoxy compound containing an isocyanate group and/or a melamine group,

wherein a content of the at least one kind selected from the group consisting of zirconium, titanium and hafnium in the chemical conversion coating agent is 20 to 10000 ppm in terms of metal, and

a content of the water-soluble epoxy compound containing the isocyanate group and/or the melamine group in the chemical conversion coating agent is 5 to 5000 ppm as a concentration of solid matter.

### TECHNICAL FIELD

The present invention relates to a chemical conversion coating agent and a surface-treated metal.

### BACKGROUND ART

When a cationic electrocoating or a powder coating is applied to the surface of a metal material, a chemical conversion treatment is generally applied in order to improve the properties such as corrosion resistance and adhesion to a coating film. With respect to a chromate treatment used in the chemical conversion treatment, from the viewpoint of being able to further improve the adhesion to a coating film and the corrosion resistance, in recent years, a harmful effect of chromium has been pointed and the development of a chemical conversion coating agent containing no chromium is required. As such a chemical conversion treatment, a treatment using zinc phosphate is widely adopted (cf. Japanese Kokai Publication Hei-10-204649, for instance).

However, since treating agents based on zinc phosphate have high concentrations of metal ions and acids and are very active, these are economically disadvantageous and low in workability in a wastewater treatment. Further, there is a problem of formation and precipitation of salts, being insoluble in water, associated with the metal surface treatment using treating agents based on zinc phosphate. Such a precipitated substance is generally referred to as sludge and increases in cost for removal and disposal of such sludge become problems. Further, there is also a problem that in a metal surface treatment using treating agents based on zinc phosphate, a surface conditioning is required; therefore, a treatment process become long.

As a metal surface treating agent other than such a treating agent based on zinc phosphate or a chemical conversion coating agent of chromate, there is known a metal surface treating agent comprising a zirconium compound (cf. Japanese Kokai Publication Hei-07-310189, for instance). Such a metal surface treating agent comprising a zirconium compound has an excellent property in point of suppressing the generation of the sludge in comparison with the treating agent based on zinc phosphate described above.

However, a chemical conversion coat attained by such a metal surface treating agent comprising a zirconium compound is poor in the adhesion to a coating film attained by various coating methods, and usually less used as a pretreatment step for coating.

As a metal surface treating agent containing a zirconium compound to improve an issue of the adhesion to a coating film described above, a metal surface treating agent comprising a zirconium compound, vanadium and resin has been developed (cf. Japanese Kokai Publication 2002-60699, for instance). However, since such a metal surface treating agent contains vanadium, it is not preferable in point of causing a problem of a harmful effect on human body and wastewater treatment.

In addition, the metal surface treating agent comprising a zirconium compound is insufficient in adhesion to an iron material; therefore, it was difficult to form a good chemical conversion coat on the iron material. Therefore, by one step of treatment to be applied to bodies and parts of automobiles comprising various metal materials such as iron, zinc and aluminum, a surface treatment for all metals cannot be performed and this agent was inefficient from the viewpoint of workability. Accordingly, there is desired the development of a chemical conversion coating agent containing no chromium and capable of applying a chemical conversion treatment to articles comprising various metal materials by one step.

### SUMMARY OF THE INVENTION

In consideration of the above circumstances, it is an object of the present invention to provide a chemical conversion coating agent containing no chromium and capable of applying good chemical conversion treatment which is equal to or more than chemical conversion treatment by zinc phosphate to all metals such as iron, zinc and aluminum.

The present invention is a chemical conversion coating agent comprising:

at least one kind selected from the group consisting of zirconium, titanium and hafnium;

fluorine; and

a water-soluble epoxy compound containing an isocyanate group and/or a melamine group,

wherein a content of the at least one kind selected from the group consisting of zirconium, titanium and hafnium in the chemical conversion coating agent is 20 to 10000 ppm in terms of metal, and

a content of the water-soluble epoxy compound containing the isocyanate group and/or the melamine group in the chemical conversion coating agent is 5 to 5000 ppm as a concentration of solid matter.

The present invention is a chemical conversion coating agent comprising:

at least one kind selected from the group consisting of zirconium, titanium and hafnium;

fluorine;

a water-soluble epoxy compound; and

a polyisocyanate compound and/or a melamine resin,

wherein a content of the at least one kind selected from the group consisting of zirconium, titanium and hafnium in the chemical conversion coating agent is 20 to 10000 ppm in terms of metal, and

a total amount of the water-soluble epoxy compound and the polyisocyanate compound and/or the melamine resin in the chemical conversion coating agent is 5 to 5000 ppm as a concentration of solid matter.

Preferably, said water-soluble epoxy compound has an amino group.

Preferably, said chemical conversion coating agent contains

1 to 5000 ppm of at least one kind of a chemical conversion reaction accelerator selected from the group consisting of nitrite ions, nitro group-containing compounds, hydroxylamine sulfate, persulfate ions, sulfite ions, hyposulfite ions, peroxides, iron (III) ions, citric acid iron compounds, bromate ions, perchlorinate ions, chlorate ions, chlorite ions as well as ascorbic acid, citric acid, tartaric acid, malonic acid, succinic acid and salts thereof.

Preferably, said chemical conversion coating agent contains

at least one kind selected from the group consisting of: at least one kind of metal ions (A) selected from the group consisting of zinc ions, magnesium ions, calcium ions, aluminum ions, manganese ions and iron ions; copper ions (B); and a silicon-containing compound (C).

Preferably, said silicon-containing compound (C) is at least one kind selected from the group consisting of silica, water-soluble silicate compounds, esters of silicic acid, alkyl silicates and silane coupling agents.

Preferably, a pH of said chemical conversion coating agent is 1.5 to 6.5.

The present invention is also a surface-treated metal having

a chemical conversion coat formed by the chemical conversion coating agent.

Preferably, said chemical conversion coat has a coat amount of 0.1 to 500 mg/m² in sum of a total amount of metals contained in the chemical conversion coating agent and carbon contained in the water-soluble epoxy compound.

Preferably, in said surface-treated metal,

a substance to be treated comprises an iron material, a zinc material and/or an aluminum material.

### DETAILED DESCRIPTION OF THE INVENTION

Hereinafter, the present invention will be described in detail.

The present invention provides a chemical conversion coating agent which contains at least one kind selected from the group consisting of zirconium, titanium and hafnium, and fluorine, but substantially contains no harmful heavy metal ions such as chromium. For example, when a metal material is treated by a zirconium-containing chemical conversion coating agent, it is considered that hydroxide or oxide of zirconium is deposited on the surface of the base material because metal ions elutes in the chemical conversion coating agent through a dissolution reaction of the metal and pH at an interface increases.

When such a chemical conversion coating agent contains an epoxy compound, the epoxy compound chelates at least one kind selected from the group consisting of zirconium, titanium and hafnium. It is estimated that this chelation provides the strong adhesion of a coat comprising the at least one kind selected from the group consisting of zirconium, titanium and hafnium to a coat of an epoxy compound. It is estimated that since the coat of an epoxy compound comprises an organic component, it has a high affinity for resin components which constitute an electrode position coating film or a coating film by powder coating to be further formed on the coat of an epoxy compound and this allows the strong adhesion to be attained.

Since the chemical conversion coating agent of the present invention further contains components which act as a curing agent, crosslinking reaction occurs in the above coat of an epoxy compound; thereby, it is possible to form an organic coat layer which has excellent physical properties and high adhesion and corrosion resistance.

At least one kind selected from the group consisting of zirconium, titanium and hafnium contained in the chemical conversion coating agent is a component constituting chemical conversion coats and, by forming a chemical conversion coat including at least one kind selected from the group consisting of zirconium, titanium and hafnium on a material, the corrosion resistance and abrasion resistance of the material can be improved and, further, the adhesion to the coating film formed subsequently can be enhanced.

A supply source of the zirconium is not particularly limited, and examples thereof include alkaline metal fluoro-zirconate such as K₂ZrF₆, fluoro-zirconate such as (NH₄)₂ZrF₆, soluble fluoro-zirconate like fluoro-zirconate acid such as H₂ZrF₆, zirconium fluoride, zirconium oxide and the like.

A supply source of the titanium is not particularly limited, and examples thereof include alkaline metal fluoro-titanate, fluoro-titanate such as (NH₄)₂TiF₆, soluble fluoro-titanate like fluoro-titanate acid such as H₂TiF₆, titanium fluoride, titanium oxide and the like.

A supply source of the hafnium is not particularly limited, and examples thereof include fluoro-hafnate acid such as H₂HfF₆, hafnium fluoride and the like.

As a supply source of at least one kind selected from the group consisting of zirconium, titanium and hafnium, a compound having at least one kind selected from the group consisting of ZrF₆²⁻, TiF₆²⁻ and HfF₆²⁻ is preferable because of high ability of forming a coat.

Preferably, the content of at least one kind selected from the group consisting of zirconium, titanium and hafnium, which is contained in the chemical conversion coating agent is within a range from 20 ppm of a lower limit to 10000 ppm of an upper limit in terms of metal. When the content is less than the above lower limit, the performance of the chemical conversion coat to be obtained is inadequate, and when the content exceeds the above upper limit, it is economically disadvantageous because further improvements of the performances cannot be expected. More preferably, the lower limit is 50 ppm and the upper limit is 2000 ppm.

Fluorine contained in the chemical conversion coating agent plays a role as an etchant of a material. A supply source of the fluorine is not particularly limited, and examples thereof include fluorides such as hydrofluoric acid, ammonium fluoride, fluoboric acid, ammonium hydrogenfluoride, sodium fluoride, sodium hydrogenfluoride and the like. In addition, an example of complex fluoride includes hexafluorosilicate, and specific examples thereof include hydrosilicofluoric acid, zinc hydrosilicofluoride, manganese hydrosilicofluoride, magnesium hydrosilicofluoride, nickel hydrosilicofluoride, iron hydrosilicofluoride, calcium hydrosilicofluoride and the like.

The chemical conversion coating agent of the present invention contains a water-soluble epoxy compound. It is considered that when the water-soluble epoxy compound is blended in the chemical conversion coating agent, an affinity for resin in a coating composition is increased by an epoxy skeleton; therefore, the adhesion to a coating films enhanced and the coating can exhibit good stability.

The water-soluble epoxy compound is not particularly limited as long as it has the solubility of a level to which it can dissolve a required amount in a chemical conversion coating agent, and a compound including an epoxy resin as a skeleton may be used. The epoxy resin is not particularly limited, and examples thereof include bisphenol A type epoxy resin, bisphenol F type epoxy resin, hydrogenated bisphenol A type epoxy resin, hydrogenated bisphenol F type epoxy resin, bisphenol A propyleneoxide addition type epoxy resin, bisphenol F propyleneoxide addition type epoxy resin, novolac type epoxy resin and the like. Among them, bisphenol F type epoxy resin is preferable and bisphenol F epichlorohydrin type epoxy resin is more preferable.

Preferably, the water-soluble epoxy compound has an amino group. Such a water-soluble epoxy compound having an amino group is a cationic compound and adjusts a balance between hydrophilic and hydrophobic properties; therefore, it has a property of becoming insoluble and precipitating when a pH of an aqueous solution increases. Therefore, the epoxy compound become prone to precipitate on the surface of metal due to an increase of a pH in an interface between metal and an aqueous solution. As a result of analysis by X-ray photoelectron spectroscopy, it became apparent that the above water-soluble epoxy compound having an amino group is precipitated on a chemical conversion coat comprising at least one kind selected from the group consisting of zirconium, titanium and hafnium. It is estimated that the resulting chemical conversion coat has such a structure, thereby improving the adhesion. The amino group is not particularly limited, and examples thereof include a —NH₂ group, a monoalkylamino group, a dialkylamino group, a monohydroxyamino group, a dihydroxyamino group, other compounds including primary, secondary and tertiary amines, and the like.

A reaction of introducing an amino group in an epoxy resin constituting the above skeleton is not particularly limited, and examples thereof include ordinary methods such as a method of mixing an epoxy resin and an amine compound in a solvent, and the like.

As an example of the water-soluble epoxy compound having an amino group, commercially available products such as ADEKARESIN EM-0436 series, ADEKARESIN EM-0436F series, ADEKARESIN EM-0718 series (each manufactured by Asahi Denka Co., Ltd.) can also be used.

The water-soluble epoxy compound may have a phosphorus element. The phosphorus element is preferably contained in the water-soluble epoxy compound as a phosphate group. The phosphate group may be partially alkylated. The phosphate group can be introduced in an epoxy compound through a reaction of the epoxy group and a phosphate compound.

The coat formed by the chemical conversion coating agent of the present invention has curability. More specifically, by containing a component causing a curing reaction after forming a coat, it improves physical properties of a coating film and forms an organic coat layer which is excellent in the adhesion and the corrosion resistance. In the present invention, it is possible to provide the obtained coat with curability by making the above chemical conversion coating agent further contain a polyisocyanate compound and/or a melamine resin or by making the above chemical conversion coating agent contain a water-soluble epoxy compound which has an isocyanate group and/or melamine group as the water-soluble epoxy compound. In addition, the chemical conversion coating agent of the present invention may use a water-soluble epoxy compound which has an isocyanate group and/or a melamine group as the above water-soluble epoxy compound is used and simultaneously contain a polyisocyanate compound and/or melamine resin.

In the case of using the chemical conversion coating agent comprising the polyisocyanate compound and/or melamine resin, the polyisocyanate compound and/or melamine resin precipitates simultaneously when the water-soluble epoxy compound precipitates, and the precipitated compound is subjected to heating and cured in the following treatment step to obtain a cured film. The polyisocyanate compound is a compound having two or more isocyanate groups, and a blocked or half-blocked polyisocyanate compound which is blocked with a blocking agent is preferably used in order to stably blend the polyisocyanate compound in the water-borne chemical conversion coating agent.

The blocked or half-blocked polyisocyanate compound is obtained by adding a blocking agent to a polyisocyanate compound and produces an isocyanate group through dissociation of the blocking agent by heating. This isocyanate group causes a crosslinking reaction with the water-soluble epoxy compound; therefore, the adhesion to a coating film is further enhanced. The polyisocyanate compound is not particularly limited, and examples thereof include aliphatic diisocyanates such as hexamethylene diisocyanate (including a trimer), tetramethylene diisocyanate and trimethylhexamethylene diisocyanate, alicyclic polyisocyanates such as isophorone diisocyanate and 4,4′-methylenebis(cyclohexyl isocyanate), aromatic diisocyanates such as 4,4′-diphenylmethane diisocyanate, trilene diisocyanate, xylylene diisocyanate, and the like.

The blocking agent is not particularly limited, and examples thereof can include monohydric alkyl (or aromatic) alcohols such as n-butanol, n-hexyl alcohol, 2-ethylhexanol, lauryl alcohol, phenol carbinol and methyl phenyl carbinol, cellosolves such as ethylene glycol monohexyl ether and ethylene glycol mono-2-ethylhexyl ether, phenols such as phenol, p-t-butylphenol and cresol, oxyms such as dimethyl ketoxym, methyl ethyl ketoxym, methyl isobutyl ketoxym, methyl amyl ketoxym and cyclohexanone ketoxym; lactams represented by ε-caprolactam and γ-butyrolactam, and the like. Since blocking agents of oxyms and lactams dissociate at a low temperature, they are more preferable from the viewpoint of curability of resin.

The melamine resin is not particularly limited, and examples thereof include alkoxymethylmelamine resin having alkoxy groups such as methoxy group, ethoxy group, n-butoxy group and i-butoxy group, and the like. The alkoxymethylmelamine resin is normally obtained by etherizing methylolmelamine resin with monohydric alcohol having 1 to 4 carbon atoms, the methylolmelamine resin being obtained by adding aldehydes such as formaldehyde and paraformaldehyde to melamine or by addition-condensing them. In the present invention, the methyl ether group is suitable.

Specific examples of the melamine resin include CYMEL 303, CYMEL 325, CYMEL 327, CYMEL 350, CYMEL 370, CYMEL 385 (each manufactured by Mitsui Cytec Co., Ltd.), SUMIMAL M40S, SUMIMAL M50S, SUMIMAL M100 (each manufactured by Sumitomo Chemical Co., Ltd.), and the like as a type having a methoxy group (methyl ether type). In addition, specific examples of the melamine resin include UVAN 20SE-60, UVAN 20SE-125, UVAN 20SE-128 (each manufactured by Mitsui Chemicals Co., Ltd.), SUPER BECKAMINE G821, SUPER BECKAMINE J820 (each manufactured by Dainippon Ink and Chemicals Co., Ltd.), MYCOAT 506, MYCOAT 508 (each manufactured Mitsui Cytec Co., Ltd.), and the like as a type having a butoxy group (butyl ether type). Further, examples of a mixed ether type melamine include CYMEL 235, CYMEL 238, CYMEL 254, CYMEL 266, CYMEL 267, CYMEL 285, CYMEL 1141 (each manufactured by Mitsui Cytec Co., Ltd.), NIKALAC MX-40, NIKALAC MX-45 (each manufactured by Sanwa Chemical Co., Ltd.), and the like.

The chemical conversion coating agent of the present invention preferably contains the water-soluble epoxy compound and the polyisocyanate compound and/or the melamine resin within a range from 5 ppm of a lower limit to 5000 ppm of an upper limit in a total amount as a concentration of solid matter. When the total amount is less than 5 ppm, there is a possibility that a proper performance after coating cannot be attained in the chemical conversion coat to be obtained, and when it exceeds 5000 ppm, there is a possibility that the chemical conversion coat is not formed efficiently. More preferably, the lower limit is 30 ppm and the upper limit is 2000 ppm.

In the chemical conversion coating agent of the present invention, when the water-soluble epoxy compound containing the isocyanate group and/or the melamine group is adopted, a cured film can be formed because crosslinking is occurred by the isocyanate group and/or a melamine group contained in the water-soluble epoxy compound.

The isocyanate group may be introduced in the water-soluble epoxy compound, for example, by reacting a half-blocked diisocyanate compound blocked with a blocking agent with the water-soluble epoxy compound.

The half-blocked diisocyanate compound may be obtained by reacting a diisocyanate compound with a blocking agent in such a rate that the isocyanate group is excessive. As the blocking agent which can be used in the above reaction, the above-described compounds may be used. Synthesis of the half-blocked diisocyanate compound and a reaction of the half-blocked diisocyanate compound and the water-soluble epoxy compound are not particularly limited and may be performed by publicly known methods.

A method of introducing the melamine group in the water-soluble epoxy compound is not particularly limited, and examples thereof include a method wherein a melamine resin such as CYMEL 385 is added to a bisphenol A type epoxy resin or a bisphenol F type epoxy resin and the mixture is stirred at 80° C. for 2 hours while being heated, and the like.

In the chemical conversion coating agent of the present invention, since the ratio of a functional group between an epoxy compound and an isocyanate group and/or a melamine group, between which curing is occurred, is maintained constant, it is more preferable to use the water-soluble epoxy compound containing the isocyanate group and/or the melamine group rather that to use the water-soluble epoxy compound and the polyisocyanate compound and/or the melamine resin.

The chemical conversion coating agent of the present invention preferably contains the water-soluble epoxy compound containing the isocyanate group and/or the melamine group within a range from 5 ppm of a lower limit to 5000 ppm of an upper limit as a concentration of solid matter. When the content is less than 5 ppm, there is a possibility that a proper performance after coating cannot be attained in the chemical conversion coat to be obtained, and when it exceeds 5000 ppm, there is a possibility that the chemical conversion coat is not formed efficiently. More preferably, the lower limit is 30 ppm and the upper limit is 2000 ppm.

Preferably, the chemical conversion coating agent of the present invention further contains a chemical conversion reaction accelerator. The chemical conversion reaction accelerator has an effect of suppressing unevenness of the surface of a chemical conversion coat obtained using a metal surface treating agent comprising a zirconium compound. An amount of a coat precipitated is different depending on the difference of location between an edge portion and a flat portion of a material; thereby, the unevenness of the surface is generated. Therefore, when a metal material having an edge portion is treated with a conventional surface treating agent comprising a zirconium compound, since an anodic dissolution reaction occurs selectively at an edge portion, a cathodic reaction becomes prone to occur and, consequently, a coat tends to precipitate around the edge portion and an anodic dissolution reaction hardly occur in a flat portion and precipitation of a coat is suppressed, and this results in unevenness of the surface.

In the chemical conversion treatment of zinc phosphate, since the resulting chemical conversion coat is a thick film type, the unevenness of the surface does not turn into problems so much. However, since the chemical conversion coat comprising a zirconium compound is a thin film type, when a sufficient amount of a coat is not attained at a flat portion to which the chemical conversion treatment is hardly applied, this causes uneven coating and problems may arise in appearance of a coating and corrosion resistance.

The chemical conversion reaction accelerator in the present invention has a property to act in such a manner that the chemical conversion treatment may be applied without developing a difference of a chemical conversion treatment reaction between the edge portion and the flat portion described above by being blended in the chemical conversion coating agent.

Although the chemical conversion reaction accelerator is at least one kind selected from the group consisting of nitrite ions, nitro group-containing compounds, hydroxylamine sulfate, persulfate ions, sulfite ions, hyposulfite ions, peroxides, iron (III) ions, citric acid iron compounds, bromate ions, perchlorinate ions, chlorate ions, chlorite ions as well as ascorbic acid, citric acid, tartaric acid, malonic acid, succinic acid and salts thereof, in particular, a substance having an oxidizing action or an organic acid is preferable for accelerating etching efficiently.

By blending these chemical conversion reaction accelerators in the chemical conversion coating agent, unbalanced coat-precipitation is adjusted and good chemical conversion coat having no unevenness in an edge portion and a flat portion of a material can be attained.

A supply source of the nitrite ion is not particularly limited, and examples thereof include sodium nitrite, potassium nitrite, ammonium nitrite and the like. The nitro group-containing compound is not particularly limited, and examples thereof include nitrobenzenesulfonic acid, nitroguanidine and the like. A supply source of the persulfate ion is not particularly limited, and examples thereof include Na₂S₂O₈, K₂S₂O₈ and the like. A supply source of the sulfite ion is not particularly limited, and examples thereof include sodium sulfite, potassium sulfite, ammonium sulfite and the like. A supply source of the hyposulfite ion is not particularly limited, and examples thereof include sodium hyposulfite, potassium hyposulfite, ammonium hyposulfite and the like. The peroxides is not particularly limited, and examples thereof include hydrogen peroxide, sodium peroxide, potassium peroxide and the like.

A supply source of the iron (III) ion is not particularly limited, and examples thereof include ferric nitrate, ferric sulfate, ferric chloride and the like. The citric acid iron compound is not particularly limited, and examples thereof include citric acid iron ammonium, citric acid iron sodium, citric acid iron potassium and the like. A supply source of the bromate ion is not particularly limited, and examples thereof include sodium bromate, potassium bromate, ammonium bromate and the like. A supply source of the perchlorinate ion is not particularly limited, and examples thereof include sodium perchlorinate, potassium perchlorinate, ammonium perchlorinate and the like.

A supply source of the chlorate ion is not particularly limited, and examples thereof include sodium chlorate, potassium chlorate, ammonium chlorate and the like. A supply source of the chlorite ion is not particularly limited, and examples thereof include sodium chlorite, potassium chlorite, ammonium chlorite and the like. The ascorbic acid and salt thereof are not particularly limited, and examples thereof include ascorbic acid, sodium ascorbate, potassium ascorbate, ammonium ascorbate and the like. The citric acid and salt thereof are not particularly limited, and examples thereof include citric acid, sodium citrate, potassium citrate, ammonium citrate and the like. The tartaric acid and salt thereof are not particularly limited, and examples thereof include tartaric acid, ammonium tartrate, potassium tartrate, sodium tartrate and the like. The malonic acid and salt thereof are not particularly limited, and examples thereof include malonic acid, ammonium malonate, potassium malonate, sodium malonate and the like. The succinic acid and salt thereof are not particularly limited, and examples thereof include succinic acid, sodium succinate, potassium succinate, ammonium succinate and the like.

The above-described chemical conversion reaction accelerators may be used alone or in combination of two or more kinds of components as required.

A blending amount of the chemical conversion reaction accelerator in the chemical conversion coating agent of the present invention is preferably within a range from 1 ppm of a lower limit to 5000 ppm of an upper limit. When it is less than 1 ppm, it is not preferred because an adequate effect cannot be attained. When it exceeds 5000 ppm, there is a possibility of inhibiting coat formation. The above lower limit is more preferably 3 ppm and further more preferably 5 ppm. The above upper limit is more preferably 2000 ppm and further more preferably 1500 ppm.

Preferably, the chemical conversion coating agent of the present invention further contains at least one kind selected from the group consisting of: at least one kind of metal ions (A) selected from the group consisting of zinc ions, magnesium ions, calcium ions, aluminum ions, manganese ions and iron ions; copper ions (B); and a silicon-containing compound (C). By containing these components, the chemical conversion coating agent can further enhance the adhesion to a coating film.

Preferably, the content of at least one kind of metal ions (A) selected from the group consisting of zinc ions, magnesium ions, calcium ions, aluminum ions, manganese ions and iron ions is within a range from 1 ppm of a lower limit to 5000 ppm of an upper limit. When the content is less than 1 ppm, it is not preferable since the corrosion resistance of the chemical conversion coat to be obtained is deteriorated. When the content exceeds 5000 ppm, it is economically disadvantageous because further improvement of the performances is not recognized, and there is a possibility that adhesion after coating is deteriorated. More preferably, the above lower limit is 20 ppm and the above upper limit is 2000 ppm.

Preferably, the content of the copper ion (B) is within a range from 0.5 ppm of a lower limit to 100 ppm of an upper limit. When the content is less than 0.5 ppm, it is not preferable since the corrosion resistance of the chemical conversion coat to be obtained is deteriorated. When the content exceeds 100 ppm, there is a possibility that a negative effect is brought about in a zinc material and an aluminum material. More preferably, the above lower limit is 2 ppm and the above upper limit is 50 ppm. The copper ion (B) has particularly a high effect of stabilizing the chemical conversion coats by applying displacement plating to the surface of a metal material and, with respect to this point, it is estimated that the copper ion can attain a high degree of effectiveness in a small amount in comparison with another components because it stabilizes rust forming on the metal material.

A supply source of the respective components (A) and (B) is not particularly limited and, for example, they can be blended in the chemical conversion coating agent as nitrate, sulfate or fluoride. Among them, nitrate is preferable because it does not adversely affect chemical conversion reaction.

The silicon-containing compound (C) is not particularly limited, and examples thereof include silica such as water-dispersed silica, water-soluble silicate compounds such as sodium silicate, potassium silicate and lithium silicate, esters of silicic acid, alkyl silicates such as diethyl silicate, a silane coupling agent, and the like. Among them, silica is preferable since it has an action of enhancing a barrier-effect of a chemical conversion coat and water-dispersed silica is more preferable since it has high dispersibility in the chemical conversion coating agent. The water-dispersed silica is not particularly limited, and examples thereof include spherical silica, chain silica, aluminum-modified silica and the like, which have less impurities such as sodium. The spherical silica is not particularly limited, and examples thereof include colloidal silica such as “SNOWTEX N”, “SNOWTEX O”, “SNOWTEX OXS”, “SNOWTEX UP”, “SNOWTEX XS”, “SNOWTEX AK”, “SNOWTEX OUP”, “SNOWTEX C” and “SNOWTEX OL”(each manufactured by Nissan Chemical Industries Co., Ltd.) and fumed silica such as “AEROSIL” (manufactured by Nippon Aerosil Co., Ltd.), and the like. The chain silica is not particularly limited, and examples thereof include silica sol such as “SNOWTEX PS-M”, “SNOWTEX PS-MO”, “SNOWTEX PS-SO” (each manufactured by Nissan Chemical Industries Co., Ltd.), and the like. Examples of the aluminum-modified silica include commercially available silica sol such as “ADELITE AT-20A” (manufactured by Asahi Denka Co., Ltd.), and the like.

Preferably, the content of the silicon-containing compound (C) is within a range from 1 ppm of a lower limit to 5000 ppm of an upper limit as a silicon component. When the content is less than 1 ppm, it is not preferable since the corrosion resistance of the chemical conversion coat to be obtained is deteriorated. When the content exceeds 5000 ppm, it is economically disadvantageous because further improvement of the performances is not recognized, and there is a possibility that adhesion after coating is deteriorated. More preferably, the above lower limit is 5 ppm and the above upper limit is 2000 ppm.

Additional examples of the silicon-containing compound (C) include a silane coupling agent and hydrolysate thereof. Although the silane coupling agent is not particularly limited, for example, an amino group-containing silane coupling agent is suitably used. By blending the chemical conversion coating agent with the amino group-containing silane coupling agent, a curing reaction is accelerated at an interface between a chemical conversion coat and a coating film formed through electrode position coating or powder coating, and adhesion between the coat and the coating film is improved. The amino group-containing silane coupling agent is not particularly limited as long as it has at least one amino group and has a siloxane linkage in a molecule.

The amino group-containing silane coupling agent is not particularly limited, and examples thereof include N-2(aminoethyl)₃-aminopropylmethyldimethoxysilane, N-2(aminoethyl)₃-aminopropyltrimethoxysilane, N-2(aminoethyl)₃-aminopropyltriethoxysilane, 3-aminopropyltrimethoxysilane, 3-aminopropyltriethoxysilane, 3-triethoxysilyl-N-(1,3-dimethyl-butylidene)propylamine, N-(vinylbenzyl)-2-aminoethyl-3-aminopropyltrimethoxysilane, N,N-bis[3-(trimethoxysilyl)propyl]ethylenediamine and the like.

The silane coupling agent may also be hydrolysate thereof. The hydrolysate of the silane coupling agent can be produced by a publicly known method, for example, a method of dissolving a silane coupling agent in ion-exchanged water and making the solution acidic with any acid.

The respective components (A), (B) and (C) may be used alone or in combination of two or more kinds of components as required. When two or more kinds of components are used simultaneously, the contents of the respective components are preferably within the above ranges, respectively, and the total amount of the respective components is not particularly limited.

Examples of a particularly preferable combination include a combination of at least one kind of metal ions (A) selected from the group consisting of zinc ions, magnesium ions, calcium ions, aluminum ions, manganese ions and iron ions and copper ions (B), and a combination of a silicon-containing compound (C) and copper ions (B).

In the chemical conversion coating agent of the present invention, a pH is preferably adjusted within a range from 1.5 of a lower limit to 6.5 of an upper limit. When the pH is less than 1.5, the adhesion to a coating film is not adequately improved in some cases since a water-soluble epoxy compound becomes hard to precipitate. When it exceeds 6.5, a chemical conversion treatment reaction does not proceed adequately in some cases. More preferably, the above lower limit is 2.0 and the above upper limit is 5.5. Still more preferably, the above lower limit is 2.5 and the above upper limit is 5.0. The chemical conversion coating agent of the present invention may contain ions of a complex fluoride, nitrate, sulfate, and salt of fluoride as described above, an alkaline component is preferably added to the coating agent in order to control a pH within the above range. An alkaline component which can be used for adjusting a pH is not particularly limited, and examples thereof include sodium hydroxide, potassium hydroxide, ammonia, amine compounds and the like.

Preferably, the chemical conversion coating agent of the present invention does not substantially contain phosphate ions. Not substantially containing means that phosphate ions are not contained to such an extent that the phosphate ions act as a component in the chemical conversion coating agent. When the above chemical conversion coating agent does not substantially contain phosphate ions, phosphorus causing a burden on the environment is not substantially used and the formation of the sludge such as iron phosphate and zinc phosphate, formed in using a treating agent of zinc phosphate, can be suppressed. Further, a burden on the environment due to phosphorus is eliminated; therefore, this becomes a large advantage in point of workability in wastewater treatment.

A method of treating a metal surface with the chemical conversion coating agent of the present invention is not particularly limited, and this method can be performed by bringing the chemical conversion coating agent into contact with the metal surface. The treatment method is not particularly limited, and examples thereof include an immersion method, a spray coating method, a roller coating method and the like.

In the treatment method, treatment is preferably conducted by controlling a temperature of a treating solution within a range from 20° C. of a lower limit to 70° C. of an upper limit. The chemical conversion treatment reaction can be performed efficiently by conducting the chemical conversion treatment reaction in such a range of temperature. More preferably, the above lower limit is 30° C. and the above upper limit is 50° C. Treatment time varies depending on a concentration of the chemical conversion coating agent and a treatment temperature, and is preferably 20 to 300 seconds.

In the treatment method, it is preferable to perform degreasing before applying the chemical conversion treatment using the chemical conversion coating agent and rinsing with water after degreasing, and postrinsing after the chemical conversion treatment.

The above degreasing is performed to remove an oil matter or a stain adhered to the surface of the material, and immersion treatment is conducted usually at 30 to 55° C. for about several minutes with a degreasing agent such as phosphate-free and nitrogen-free cleaning liquid for degreasing. It is also possible to perform pre-degreasing before degreasing as required.

The above rinsing with water after degreasing is performed by spraying once or more with a large amount of water for rinsing in order to rinse a degreasing agent after degreasing.

The above postrinsing after the chemical conversion treatment is performed once or more in order to prevent the chemical conversion treatment from adversely affecting to the adhesion and the corrosion resistance after the subsequent various coating applications. In this case, it is proper to perform the final rinsing with pure water. In this postrinsing after the chemical conversion treatment, either spray rinsing or immersion rinsing may be used, and a combination of these rinsing may be adopted.

In addition, since the chemical conversion treatment using the chemical conversion coating agent of the present invention does not need to conduct a surface conditioning, it is excellent in workability.

In the chemical conversion treatment using the chemical conversion coating agent of the present invention, a drying step after the postrinsing after the chemical conversion treatment is not necessarily required. Even though coating is performed with the chemical conversion coats being wet without drying, the resulting performance is not affected. When drying is performed, it is preferable to dry with cool air or hot air. When hot air drying is selected, air temperature is preferably 300° C. or less to prevent the degradation of an organic matter.

Examples of a metal material treated with the chemical conversion coating agent of the present invention include an iron material, an aluminum material, a zinc material and the like. Iron, aluminum and zinc materials mean an iron material in which a material comprises iron and/or its alloy, an aluminum material in which a material comprises aluminum and/or its alloy and a zinc material in which a material comprises zinc and/or its alloy, respectively. The chemical conversion coating agent of the present invention can also be used for chemical conversion treatment of a substance to be coated comprising a plurality ofinetal materials among the iron material, the aluminum material and the zinc material.

The chemical conversion coating agent of the present invention is preferable in point of being able to form good coating films to iron materials to which it is hard to supply sufficient adhesion to a coating film by usual chemical conversion coating agents of zirconium and the like; therefore, it can also be applied for treating a substance to be treated which contains an iron material at least in part. Accordingly, the chemical conversion coating agent of the present invention has an excellent property particularly in application to iron materials. A surface-treated metal having the chemical conversion coat formed by using the chemical conversion coating agent of the present invention is also one of the present invention.

The iron material is not particularly limited, and examples thereof include a cold-rolled steel sheet, a hot-rolled steel sheet and the like. The aluminum material is not particularly limited, and examples thereof include 5000 series aluminum alloy, 6000 series aluminum alloy and the like. The zinc material is not particularly limited, and examples thereof include steel sheets, which are plated with zinc or a zinc-based alloy through electroplating, hot dipping and vacuum evaporation coating, such as a galvanized steel sheet, a steel sheet plated with a zinc-nickel alloy, a steel sheet plated with a zinc-iron alloy, a steel sheet plated with a zinc-chromium alloy, a steel sheet plated with a zinc-aluminum alloy, a steel sheet plated with a zinc-titanium alloy, a steel sheet plated with a zinc-magnesium alloy and a steel sheet plated with a zinc-manganese alloy, and the like. By using the above chemical conversion coating agent, chemical conversion treatment with iron, aluminum and zinc materials can be conducted simultaneously.

Preferably, a coat amount of the chemical conversion coat obtained by the chemical conversion coating agent of the present invention is within a range from 0.1 mg/m² of a lower limit to 500 mg/m² of an upper limit in sum of a total amount of metals contained in the chemical conversion coating agent and carbon contained in the water-soluble epoxy compound. When this coat amount is less than 0.1 mg/m² it is not preferable since a uniform chemical conversion coat cannot be attained. When it exceeds 500 mg/m², it is economically disadvantageous. More preferably, the above lower limit is 5 mg/m² and the above upper limit is 200 mg/m².

Coating which can be applied to a metal material having the chemical conversion coat formed by the chemical conversion coating agent of the present invention is not particularly limited, and conventionally publicly known coating such as cationic electrocoating and powder coating can be conducted. Particularly, good treatment can be applied to all metals such as iron, zinc and aluminum; therefore, it can be suitably used as pretreatment of cationic electrocoating of a substance to be treated, at least a part of which comprises an iron material. The cationic electrocoating is not particularly limited, and a publicly known cationic electrode position coating composition comprising aminated epoxy resin, aminated acrylic resin, sulfonated epoxy resin and the like can be applied.

The chemical conversion coating agent of the present invention is a chemical conversion coating agent containing at least one kind selected from the group consisting of zirconium, titanium and hafnium as a component constituting a coat. Since the chemical conversion coat formed by the chemical conversion coating agent of the present invention has good adhesion to a coating film, it can be adopted as pretreatment of a metal surface for improving the adhesion of metal to a coating film. In addition, the chemical conversion coating agent of the present invention can form a good chemical conversion coat to iron materials to which sufficient adhesion cannot be supplied by conventional chemical conversion coating agents containing zirconium and the like, and by only treating once a substance to be coated comprising various metal materials such as iron, zinc, aluminum and like, surface treatment for all metals can be performed.

The chemical conversion coating agent of the present invention does not need to use heavy metals, which has a large burden on the environment, such as chromium, and is also excellent in point of workability and cost since a good chemical conversion coat is formed without conditioning the surface in chemical conversion treatment using the chemical conversion coating agent of the present invention. Further, the chemical conversion coating agent of the present invention can be suitably applied to a substance to be treated, which contains an iron material at least in part, since the chemical conversion coating agent can provide an iron material with sufficient adhesion to a coating film.

### EXAMPLES

Hereinafter, the present invention will be described in more detail by way of examples, but the present invention is not limited to these examples. Herein, a term “part” means “part by mass” and “%” means “% by mass” in the examples, unless otherwise specified.

### Production Example 1

### (Method of Producing an Amino Group-Containing Water-Soluble Epoxy Compound A)

To 190 parts by mass of bisphenol F epichlorohydrin type epoxy compound having an epoxy equivalent of 190 was added 30 parts of diethanolamine and 110 parts of cellosolve acetate, and the mixture was reacted at 100° C. for 2 hours to obtain an amino group-containing water-soluble epoxy compound A of non-volatile content of 70%.

### Production Example 2

### (Method of Producing an Amino Group-Containing Water-Soluble Epoxy Compound B Having a Phosphorus Element)

In 190 parts by mass of bisphenol F epichlorohydrin type epoxy compound having an epoxy equivalent of 190 was blended 38 parts of monoethyl phosphate, and the mixture was stirred at 130° C. for 3 hours to obtain an epoxy resin having a phosphorus element. Further, 30 parts of diethanolamine and 110 parts of cellosolve acetate were added to the resulting epoxy resin and the mixture was reacted at 100° C. for 2 hours to obtain an amino group-containing water-soluble epoxy compound B, having a phosphorus element, of non-volatile content of 70%.

### Production Example 3

### (Method of Producing an Amino Group-Containing Water-Soluble Epoxy Compound C Having an Isocyanate Group)

100 parts of 2,4-toluenediisocyanate precopolymer of trimethylolpropane of NCO of 13.3% and non-volatile content of 75%, 44 parts of nonylphenol, 5 parts of dimethylbenzylamine and 65 parts of cellosolve acetate were mixed, and the mixture was stirred and reacted at 80° C. for 3 hours in an atmosphere of nitrogen to obtain a partially blocked polyisocyanate of non-volatile content of 70% and NCO of 20%.

The amino group-containing water-soluble epoxy compound A (70 parts) prepared in Production Example 1 and 30 parts of the above partially blocked polyisocyanate were mixed, the mixture was stirred and reacted at 80° C. for 4 hours, and then it was verified by an infrared spectroscopy that absorption of a NCO group disappeared completely. Then, 3 parts of acetic acid was added to the mixture and further the mixture was diluted with ion-exchanged water to obtain an amino group-containing water-soluble epoxy compound C having an isocyanate group, in which non-volatile content was 25% and a pH was 4.1.

### Production Example 4

### (Method of Producing an Amino Group-Containing Water-Soluble Epoxy Compound D Having a Phosphorus Element and an Isocyanate Group)

An amino group-containing water-soluble epoxy compound D having a phosphorus element and an isocyanate group was obtained by following the same procedure as that of Production Example 3 except that the amino group-containing water-soluble epoxy compound B having a phosphorus element prepared in Production Example 2 was used in place of the amino group-containing water-soluble epoxy compound A prepared in Production Example

### Production Example 5

### (Method of Producing an Amino Group-Containing Water-Soluble Epoxy Compound E Having a Phosphorus Element and an Isocyanate Group)

An amino group-containing water-soluble epoxy compound E having a phosphorus element and an isocyanate group was obtained by following the same procedure as that of Production Example 4 except that a bisphenol A epichlorohydrin type epoxy compound having an epoxy equivalent of 500 was used in place of a bisphenol F epichlorohydrin type epoxy resin having an epoxy equivalent of 190 and further 65 parts of N-methylethanolamine and 245 parts of cellosolve acetate were used in place of 30 parts of diethanolamine and 110 parts of cellosolve acetate in amine-addition.

### Production Example 6

### (Method of Producing an Amino Group-Containing Water-Soluble Epoxy Compound G Having an Isocyanate Group)

An amino group-containing water-soluble epoxy compound F was obtained by following the same procedure as that of Production Example 2 except that a bisphenol A epichlorohydrin type epoxy compound having an epoxy equivalent of 190 was used in place of a bisphenol F epichlorohydrin type epoxy resin having an epoxy equivalent of 190. To another reactor was charged 174 parts of 2,4-toluenediisocyanate, 96 parts of phenol, 5 parts of dimethylbenzylamine and 118 parts of ethyl acetate, and the mixture was stirred and reacted at 80° C. for 3 hours in an atmosphere of nitrogen to obtain a partially blocked isocyanate of non-volatile content of 70% and NCO of 10.6%. This partially blocked isocyanate (30 parts) and 70 parts of the amino group-containing water-soluble epoxy compound F were reacted at 80° C. for 4 hours while being stirred. After it was verified by an infrared spectroscopy that absorption of a NCO group disappeared completely, 3 parts of acetic acid was added to the mixture and the mixture was diluted with ion-exchanged water to obtain an amino group-containing water-soluble epoxy compound G having an isocyanate group, in which non-volatile content was 25% and a pH was 4.1.

### Examples 1 to 16, Comparative Examples 5 to 15

A commercially available cold-rolled steel sheet (SPCC-SD, manufactured by Nippon Testpanel Co., Ltd., 70 mm×150 mm×0.8 mm), a galvanized steel sheet (GA steel sheet, manufactured by Nippon Testpanel Co., Ltd., 70 mm×150 mm×0.8 mm), 5000 series aluminum (manufactured by Nippon Testpanel Co., Ltd., 70 mm×150 mm×0.8 mm) or 6000 series aluminum (manufactured by Nippon Testpanel Co., Ltd., 70 mm×150 mm×0.8 mm) was used as a material and pretreatment of coating was applied to these material in the following conditions.

(1) Pretreatment of Coating

Degreasing treatment: The metal materials were immersed at 40° C. for 2 minutes with 2% by mass “SURF CLEANER EC92” (degreasing agent manufactured by Nippon Paint Co., Ltd.).

Rinsing after degreasing: The metal materials were rinsed for 30 seconds with a spray of running water.

Chemical conversion treatment: Chemical conversion coating agents having compositions shown in Tables 1 and 2 were prepared and chemical conversion treatment was conducted by immersing the metal materials in the chemical conversion coating agents under the conditions described in Tables 1 and 2. Herein, nitric acid and sodium hydroxide were used for adjusting a pH.

Postrinsing after the chemical conversion treatment: The metal materials were rinsed for 30 seconds with a spray of running water. In addition, they were rinsed for 30 seconds with a spray of ion-exchanged water. Electrocoating was applied to the metal materials rinsed with water as is wet without drying it. But, the chemical conversion coats obtained in Examples 14 and 16 and Comparative Example 14 were dried with cool air and then electrocoating was applied to them.

(2) Coating

After 1 m² Of the surface of the metal materials were treated per 1 liter of the chemical conversion coating agent, electrocoating was applied to the surface in such a manner that a dried film thickness was 20 μm using “POWERNIX 110” (a cationic electrode position coating composition manufactured by Nippon Paint Co., Ltd.) and, after rinsing with water, the metal materials were heated and baked at 170° C. for 20 minutes and test sheets were prepared.

### Comparative Examples 1 to 4

Test sheets were obtained by following the same procedure as that of Example 1 except that chemical conversion treatment was conducted by conditioning the surface at a room temperature for 30 seconds using “SURF FINE 5N-8M” (manufactured by Nippon Paint Co., Ltd.) after rinsing after degreasing and by immersing the test sheets at 35° C. for 2 minutes using “SURF DYNE SD-6350” (a zinc phosphate-base chemical conversion coating agent manufactured by Nippon Paint Co., Ltd.) The pHs of the chemical conversion coating agents and treatment conditions are as shown in Table 2.

### Examples 17 to 20

Using DURANATE E402 (produced by Asahi Kasei Co., Ltd.) as a polyisocyanate compound and CYMEL 385 (produced by Mitsui Cytec Co., Ltd.) as a melamine resin, the chemical conversion coating agents having compositions shown in Table 3 were prepared and test plates were prepared in the same manner as Example 1.

TABLE 1

| | | | | | Chemical | | | |
|---|---|---|---|---|---|---|---|---|
| | | | | | conversion | | | |
| Example | | Epoxy | | | reaction | | Treatment | Temperature |
| No | Zr/Ti¹⁾ | compound | Metal ions | Si compound | accelerator | pH | time (sec) | (° C.) |
| 1 | Zr (100 ppm) | D (300 ppm) | — | — | — | 4 | 60 | 40 |
| 2 | Zr (100 ppm) | E (300 ppm) | Zn (500 ppm) | — | — | 4 | 60 | 40 |
| 3 | Zr/Ti | D (4000 ppm) | Mg (300 ppm) + Ca (100 ppm) | — | — | 3.5 | 120 | 40 |
| | (250/100) | | | | | | | |
| 4 | Zr (8000 ppm) | C (1000 ppm) | Mg (800 ppm) | SiO₂ (3 ppm) | — | 2.5 | 90 | 25 |
| 5 | Zr (30 ppm) | D (100 ppm) | Zn (2 ppm) + Mg (2 ppm) + | A (50 ppm) | — | 6 | 90 | 60 |
| | | | Al (2 ppm) | | | | | |
| 6 | Zr (100 ppm) | E (300 ppm) | Cu (5 ppm) | — | — | 4 | 60 | 40 |
| 7 | Zr (100 ppm) | E (100 ppm) | Zn (300 ppm) + Mn (30 ppm) | B (100 ppm) | — | 3 | 90 | 40 |
| 8 | Zr (250 ppm) | D (500 ppm) | Zn (500 ppm) | C (4500 ppm) | — | 4 | 60 | 40 |
| 9 | Zr (500 ppm) | C (300 ppm) | Mg (500 ppm) | D (100 ppm) | — | 4 | 60 | 40 |
| 10 | Zr (250 ppm) | D (300 ppm) | Fe (100 ppm) + Zn (200 ppm) | SiO₂ (50 ppm) | — | 4.5 | 1000 | 35 |
| 11 | Zr (100 ppm) | E (200 ppm) | Cu (5 ppm) | SiO₂ | — | 4 | 120 | 40 |
| | | | | (100 ppm) | | | | |
| 12 | Ti (1000 ppm) | C (500 ppm) | Zn (100 ppm) | A (100 ppm) | — | 4 | 60 | 35 |
| 13 | Zr (3000 ppm) | E (300 ppm) | Zn (500 ppm) | SiO₂ | — | 3.5 | 60 | 40 |
| | | | | (200 ppm) | | | | |
| 14 | Zr (250 ppm) | G (300 ppm) | Zn (1000 ppm) + Mg (500 ppm) | SiO₂ | Nitrobenzenesulfonic | 4 | 60 | 40 |
| | | | | (300 ppm) | acid (500 ppm) | | | |
| 15 | Zr (100 ppm) | G (300 ppm) | — | — | Hydrogen | 2.5 | 10 | 60 |
| | | | | | peroxide (2 ppm) | | | |
| 16 | Zr (500 ppm) | G (100 ppm) | Zn (1000 ppm) + Mg (500 ppm) | A (30 ppm) | Citric | 4 | 10 | 40 |
| | | | | | acid (1000 ppm) | | | |

Note 1: H₂ZrF₆ was used as a source of Zr, and H₂TiF₆ was used as a source Ti.

Note 2: The concentrations of metal ions of Zr, Ti and the like are concentrations as metal components.

Note 3: The concentration of an epoxy compound is represented as a concentration of solid matter. Epoxy compound H; DENACAST EM-101 (manufactured by Nagase Co., Ltd., water-dispersed epoxy resin formed by emulsifying bisphenol epichlorohydrin type epoxy resin)

Note 4: The concentrations of SiO₂ and sodium silicate are represented as a concentration of Si component.

Si compound A; KBP-90 (manufactured by Shin-Etsu Chemical Co., Ltd.)

Si compound B; γ-aminopropyltriethoxysilane (manufactured by Shin-Etsu Chemical Co., Ltd.)

Si compound C; This is produced by adding acetic acid to Si compound B, adjusting a pH of the mixture to 4 and then hydrolyzing the mixture at a room temperature for three days.

Si compound D; γ-glycidoxypropyltriethoxysilane (manufactured by Shin-Etsu Chemical Co., Ltd.)

Note 5: Treated materials are as follows:

SPC; cold-rolled steel sheet; SPCC-SD (manufactured by Nippon Testpanel Co., Ltd.)

GA; galvanized steel sheet (manufactured by Nippon Testpanel Co., Ltd.)

5000Al; 5000 series aluminum (manufactured by Nippon Testpanel Co., Ltd.)

6000Al; 6000 series aluminum (manufactured by Nippon Testpanel Co., Ltd.)

Note 6: As the respective metals, nitrates were used.

TABLE 2

| | | | | | Chemical | | | |
|---|---|---|---|---|---|---|---|---|
| Com- | | | | | conversion | | Treat- | |
| parative | | | | | reaction | | ment | |
| Example | | Epoxy | | | accel- | | time | Temperature |
| No | Zr/Ti¹⁾ | compond | Metal ions | Si compound | erator | pH | (sec) | (° C.) |
| 1 | Zinc | — | — | — | — | — | 120 | 35 |
| | phosphate | | | | | | | |
| 2 | Zinc | — | — | — | — | — | 120 | — |
| | phosphate | | | | | | | |
| 3 | Zinc | — | — | — | — | — | 120 | — |
| | phosphate | | | | | | | |
| 4 | Zinc | — | — | — | — | — | 120 | — |
| | phosphate | | | | | | | |
| 5 | Zr (500 ppm) | A (500 ppm) | Zn (500 ppm) | SiO₂ (500 ppm) | — | 4 | 60 | 40 |
| 6 | Zr (250 ppm) | B (25 ppm) | Zn (500 ppm) + Mg (500 ppm) | — | — | 4 | 60 | 40 |
| 7 | Ti (250 ppm) | B (500 ppm) | Cu (80 ppm) | — | — | 4 | 10 | 35 |
| 8 | Zr (500 ppm) | A (500 ppm) | — | Sodium silicate | — | 4 | 60 | 40 |
| | | | | (0.5 ppm) | | | | |
| 9 | Zr (100 ppm) | H (300 ppm) | — | — | — | 4 | 60 | 40 |
| 10 | Zr | H (20000 ppm) | Fe (15000 ppm) | SiO₂ (12000 ppm) | — | 4 | 60 | 40 |
| | (15000 ppm) | | | | | | | |
| 11 | Zr (100 ppm) | H (100 ppm) | Cu (200 ppm) | — | — | 4 | 90 | 40 |
| 12 | Zr (10 ppm) | H (500 ppm) | Mn (0.5 ppm) | Sodium silicate | — | 4 | 3 | 18 |
| | | | | (0.5 ppm) | | | | |
| 13 | Zr (250 ppm) | — | — | — | Citric acid iron | 4 | 60 | 40 |
| | | | | | ammonium | | | |
| | | | | | (0.5 ppm) | | | |
| 14 | Zr (200 ppm) | — | Co (100 ppm) | — | Sodium bromate | 4 | 60 | 75 |
| | | | | | (6000 ppm) | | | |
| 15 | Ti (10 ppm) | — | Zn (0.5 ppm) + Al (0.5 ppm) + Cu | SiO₂ (0.5 ppm) | Sodium nitrite | 4 | 60 | 40 |
| | | | (0.1 ppm) | | (10000 ppm) | | | |

TABLE 3

| | | | | | | Treatment | |
|---|---|---|---|---|---|---|---|
| | | Epoxy | Polyisocyanate | Melamine | | time | Temperature |
| No | Zr/Ti | compound | compound | resin | pH | (sec) | (° C.) |
| Example 17 | Zr (100 ppm) | H (250 ppm) | 50 ppm | 0 ppm | 3.5 | 60 | 40 |
| Example 18 | Zr (200 ppm) | B (250 ppm) | 25 ppm | 25 ppm | 4.0 | 60 | 35 |
| Example 19 | Zr (100 ppm) | H (300 ppm) | 0 ppm | 100 ppm | 4.5 | 60 | 40 |
| Example 20 | Zr (150 ppm) | A (300 ppm) | 3 ppm | 3 ppm | 3.7 | 60 | 40 |

Evaluation Test

<Coat Amount>

A coat amount was represented by the sum of a total amount of metals contained in the chemical conversion coating agent and carbon contained in the water-soluble epoxy compound, in the coat obtained. The total amount of metals was measured by using “XRF-1700” (X-ray fluorescence spectrometer manufactured by Shimadzu Co., Ltd.) and the amount of carbon contained in the epoxy compound was measured by using “RC 412” (a moisture content analyzer manufactured by LECO Co., Ltd. USA).

<Appearance of Bath>

After 1 m² of the surface of the metal material was treated per 1 liter of the chemical conversion coating agent, haze in the chemical conversion coating agent was observed visually. Results of evaluation are shown in Table 4.

O: There is not haze

X: There is haze

<Secondary Adhesion Test (SDT)>

Two parallel lines, which have depth reaching the material, were cut in a longitudinal direction on the obtained test sheet and then the test sheet was immersed at 50° C. for 480 hours in 5% aqueous solution of NaCl. After immersion, a cut portion was peeled off with an adhesive tape and peeling of a coating was observed.

⊚: No peeled

O: Slightly peeled

X: Peeled 3 mm or more in width

Results of observations are shown in Table 4.

<Combined Cycle Corrosion Test (CCT)>

After the test sheet, which was obtained by applying electrocoating in Examples and Comparative Examples, was cut with a cutter, a cycle test was repeated by 60 times. This cycle comprises a wet step 1 (2 hours, 40° C., humidity 95%), salt spraying (2 hours, 5% aqueous solution of NaCl, 35° C.), a drying step 1 (2 hours, 60° C.), a wet step 2 (6 hours, 50° C., humidity 95%), a drying step 2 (2 hours, 60° C.), a wet step 3 (6 hours, 50° C., humidity 95%). After cycle test, a maximum width of blister on both sides of a cut portion was measured. Evaluation criteria are as follows.

⊚: 0 to 3.5 mm or less

O: 3.6 mm to less than 7 mm

X: 7 mm or more

Results of evaluations are shown in Table 4.

TABLE 4

| | | | | | Combined |
|---|---|---|---|---|---|
| | | | Coat | | cycle |
| | Appearance | | amount | | corrosion |
| No | of bath | Materials | (mg/m2) | SDT | test (CCT) |
| Ex. 1 | ◯ | SPC | 28 | ⊚ | ⊚ |
| Ex. 2 | ◯ | SPC | 43 | ⊚ | ⊚ |
| Ex. 3 | ◯ | GA | 57 | ⊚ | ⊚ |
| Ex. 4 | ◯ | GA | 83 | ⊚ | ⊚ |
| Ex. 5 | ◯ | 5000Al | 5 | ⊚ | ⊚ |
| Ex. 6 | ◯ | SPC | 31 | ⊚ | ⊚ |
| Ex. 7 | ◯ | SPC | 68 | ◯ | ◯ |
| Ex. 8 | ◯ | SPC | 47 | ⊚ | ⊚ |
| Ex. 9 | ◯ | SPC | 69 | ⊚ | ⊚ |
| Ex. 10 | ◯ | GA | 366 | ⊚ | ⊚ |
| Ex. 11 | ◯ | SPC | 53 | ⊚ | ⊚ |
| Ex. 12 | ◯ | 5000Al | 73 | ⊚ | ⊚ |
| Ex. 13 | ◯ | SPC | 112 | ⊚ | ⊚ |
| Ex. 14 | ◯ | SPC | 155 | ⊚ | — |
| Ex. 15 | ◯ | GA | 13 | ⊚ | — |
| Ex. 16 | ◯ | 5000Al | 57 | ⊚ | — |
| Ex. 17 | ◯ | SPC | 45 | ⊚ | ⊚ |
| Ex. 18 | ◯ | GA | 61 | ⊚ | ⊚ |
| Ex. 19 | ◯ | 5000Al | 47 | ⊚ | ⊚ |
| Ex. 20 | ◯ | GA | 53 | ⊚ | ⊚ |
| Compar. Ex. 1 | X | SPC | 2400 | ⊚ | ◯ |
| Compar. Ex. 2 | X | GA | 3200 | ⊚ | ⊚ |
| Compar. Ex. 3 | X | 5000Al | 1800 | ⊚ | ⊚ |
| Compar. Ex. 4 | X | 6000Al | 1900 | ⊚ | ⊚ |
| Compar. Ex. 5 | ◯ | SPC | 72 | X | X |
| Compar. Ex. 6 | ◯ | SPC | 68 | X | X |
| Compar. Ex. 7 | ◯ | GA | 52 | ◯ | X |
| Compar. Ex. 8 | ◯ | 6000Al | 60 | ◯ | X |
| Compar. Ex. 9 | — | SPC | 35 | X | X |
| Compar. Ex. | X | SPC | 553 | X | X |
| 10 | | | | | |
| Compar. Ex. | ◯ | 5000Al | 57 | X | X |
| 11 | | | | | |
| Compar. Ex. | ◯ | SPC | 0.05 | X | X |
| 12 | | | | | |
| Compar. Ex. | X | SPC | 25 | X | — |
| 13 | | | | | |
| Compar. Ex. | ◯ | SPC | 1 | X | — |
| 14 | | | | | |
| Compar. Ex. | ◯ | SPC | 2.5 | X | — |
| 15 | | | | | |

Table 4 shows that there was not the formation of sludge in the chemical conversion coating agent of the present invention and the chemical conversion coat obtained by the chemical conversion coating agent of the present invention has the good adhesion to a coating film even in an iron material. On the other hand, the chemical conversion coat obtained by the chemical conversion coating agent prepared in Comparative Examples could not yield good results in every items.

1. A chemical conversion coating agent comprising:
at least one kind selected from the group consisting of zirconium, titanium and hafnium;
fluorine; and
a water-soluble epoxy compound containing an isocyanate group and/or a melamine group,
wherein a content of the at least one kind selected from the group consisting of zirconium, titanium and hafnium in the chemical conversion coating agent is 20 to 10000 ppm in terms of metal, and
a content of the water-soluble epoxy compound containing the isocyanate group and/or the melamine group in the chemical conversion coating agent is 5 to 5000 ppm as a concentration of solid matter.

2. A chemical conversion coating agent comprising:
at least one kind selected from the group consisting of zirconium, titanium and hafnium;
fluorine;
a water-soluble epoxy compound; and
a polyisocyanate compound and/or a melamine resin,
wherein a content of the at least one kind selected from the group consisting of zirconium, titanium and hafnium in the chemical conversion coating agent is 20 to 10000 ppm in terms of metal, and
a total amount of the water-soluble epoxy compound and the polyisocyanate compound and/or the melamine resin in the chemical conversion coating agent is 5 to 5000 ppm as a concentration of solid matter.

3. The chemical conversion coating agent according to claim 1 or 2,
wherein the water-soluble epoxy compound has an amino group.

4. The chemical conversion coating agent according to any of claims 1 to 3, containing
1 to 5000 ppm of at least one kind of a chemical conversion reaction accelerator selected from the group consisting of nitrite ions, nitro group-containing compounds, hydroxylamine sulfate, persulfate ions, sulfite ions, hyposulfite ions, peroxides, iron (III) ions, citric acid iron compounds, bromate ions, perchlorinate ions, chlorate ions, chlorite ions as well as ascorbic acid, citric acid, tartaric acid, malonic acid, succinic acid and salts thereof.

5. The chemical conversion coating agent according to any of claims 1 to 4, containing
at least one kind selected from the group consisting of: at least one kind of metal ions (A) selected from the group consisting of zinc ions, magnesium ions, calcium ions, aluminum ions, manganese ions and iron ions; copper ions (B); and a silicon-containing compound (C).

6. The chemical conversion coating agent according to any of claims 1 to 5,
wherein the silicon-containing compound (C) is at least one kind selected from the group consisting of silica, water-soluble silicate compounds, esters of silicic acid, alkyl silicates and silane coupling agents.

7. The chemical conversion coating agent according to any of claims 1 to 6,
wherein a pH thereof is 1.5 to 6.5.

8. A surface-treated metal having
a chemical conversion coat formed by the chemical conversion coating agent according to any of claims 1 to 7.

9. The surface-treated metal according to claim 8,
wherein the chemical conversion coat has a coat amount of 0.1 to 500 mg/m² in sum of a total amount of metals contained in the chemical conversion coating agent and carbon contained in the water-soluble epoxy compound.

10. The surface-treated metal according to claim 8 or 9,
wherein a substance to be treated comprises an iron material, a zinc material and/or an aluminum material.
